(19) United States
(12) Patent Application Publication
(10) Pub. No.: US 2003/0227569 A1
(43) Pub. Date: Dec. 11, 2003

(54) Automatic control apparatus and method for adaptively optimizing television viewing conditions

(75) Inventor: Joon-Hwan Kim, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/439,241

(22) Filed: May 16, 2003

(30) Foreign Application Priority Data
Jun. 11, 2002 (KR) 2002-32522

(51) Int. Cl. H04N 5/44

(52) U.S. Cl. 348/553; 348/569

(57) ABSTRACT

There is provided a TV automatic control apparatus and method for adaptively optimizing TV viewing conditions in accordance with a type of TV program. The automatic control apparatus includes a memory storing information on a TV viewing condition in a corresponding area of a control mode table, categorized by programs; a TV signal receiving unit receiving TV signals; a demultiplexer separating video signals, audio signals, and additional information signals from the received TV signals; a controller determining the type of the current program, reading the information on TV viewing conditions, which corresponds to the type of the current program from the memory, and setting up TV viewing conditions according to the information read from the memory; and a signal processor processing the video signals and the audio signals output from the demultiplexer in accordance with the TV viewing conditions.

### BACKGROUND OF THE INVENTION

This application claims the priority of Korean Patent Application No. 2002-32522, filed on Jun. 11, 2002, in the Korean Intellectual Property Office, the disclosure of which is incorporated herein in its entirety by reference.

1. Field of the Invention

The present invention relates to an apparatus and method for controlling a television (TV) receiver, and more particularly, to a TV automatic control apparatus and method for adaptively optimizing TV viewing conditions in accordance with a type of TV program.

2. Description of the Related Art

In the related art, optimum tuning points of images and sounds in a TV vary according to the type of received program. That is, according to the type of TV program such as news, movies, concerts, sports, etc., the settings of a TV should be adjusted for a user to enjoy images and sounds in optimum conditions.

Therefore, a related art TV typically adopts various control modes for adjusting TV viewing conditions in accordance with the type of TV program, (e.g., image control modes, sound control modes, and additional modes for setting up other TV viewing conditions).

The image control modes may be subdivided into, e.g., a smooth image mode, a sharp image mode, and a standard image mode. Further, the image control modes typically include a user control mode in which a user or a viewer can directly adjust the brightness, contrast, color, resolution, etc.

Likewise, the sound control modes may be subdivided into, e.g., a news sound mode, a movie sound mode, a music sound mode, and a sports sound mode. Further, the sound control modes typically include a user control mode in which a user can directly select an audio mode among mono, stereo, surround, etc.

However, the related art TV has various problems and disadvantages. For example, but not by way of limitation, although a TV typically adopts various control modes as described above, in order to constantly view and listen to every TV program under optimum conditions, a user must manually reset the control modes to adjust the state of the images and sounds or other TV viewing conditions in accordance with the type of TV program that the user wishes to enjoy. Therefore, users experience inconveniences in the related art.

### SUMMARY OF THE INVENTION

The present invention provides an automatic TV control apparatus and method for adaptively optimizing TV viewing conditions in accordance with the type of TV program.

According to an aspect of the present invention, there is provided an automatic control apparatus for adaptively optimizing television (TV) viewing conditions in a TV signal processing device, including a memory that stores information indicative of a viewing condition in a corresponding area of a control mode table, wherein said information is categorized according to at least program, a signal receiving unit that receives a signal, and a demultiplexer that separates a video signal, an audio signal, and an additional information signal from the received signal. Also provided is a controller that determines a type of a current program, reads the information on the viewing condition, which corresponds to the type of the current program, from the memory, and sets up the viewing condition according to the information read from the memory, and a signal processor that processes the video signal and the audio signal output from the demultiplexer in accordance with the viewing condition.

Further, an automatic control method of adaptively optimizing television (TV) viewing conditions in a TV signal processing device is provided. The method includes the steps of (a) determining a type of a current program based on additional information included in a received signal, (b) when the type of the current program determined in step (a) is different from a type of the previous program for which viewing conditions have been set, reading information from a memory on a viewing condition that corresponds to the type of the current program, and (c) resetting the viewing conditions in accordance with the information read from the memory in step (b). Also, a computer readable medium for storing a set of instructions for adaptively optimizing television (TV) viewing conditions in a TV signal processing device may be used to implement the aforementioned steps.

### BRIEF DESCRIPTION OF THE DRAWINGS

The above and other aspects and advantages of the present invention will become more apparent by describing preferred embodiments thereof with reference to the attached drawings in which:

FIG. 1 is a block diagram of an automatic control apparatus for adaptively optimizing TV viewing conditions according to an exemplary, non-limiting embodiment of the present invention; and

FIG. 2 is a flowchart of an automatic control method of adaptively optimizing TV viewing conditions according to an exemplary, non-limiting embodiment of the present invention.

### DETAILED DESCRIPTION OF THE INVENTION

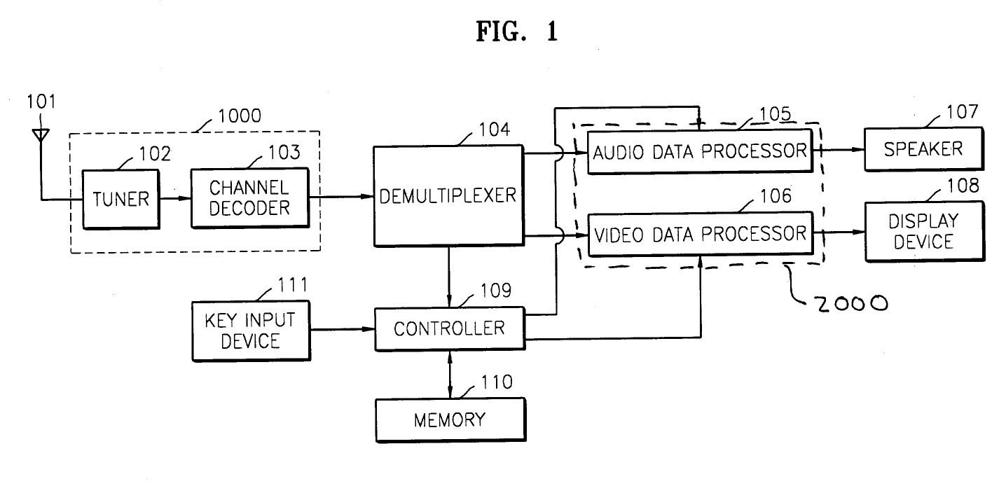

FIG. 1 illustrates an automatic control apparatus for adaptively optimizing TV viewing conditions according to an exemplary, non-limiting embodiment of the present invention. An antenna 101, a tuner 102, a channel decoder 103, a demultiplexer 104, an audio data processor 105, a video data processor 106, a speaker 107, a display device 108, a controller 109, a memory 110, and a key input device 111 are provided. While the antenna 101 is provided, the present invention is not limited thereto, and other means of obtaining a channel may also be used.

A circuit block including the tuner 102 and the channel decoder 103 is called a TV signal receiving unit 1000, and a circuit block including the audio data processor 105 and the video data processor 106 is called a TV signal processing unit 2000.

When a TV is powered on and a channel is selected using keys of the key input device 111, the tuner 102 selects the TV signals corresponding to the selected channel among TV signals received through the antenna 101, and outputs the selected TV signals to the channel decoder 103. Then, the channel decoder 103 restores digital signals detected from the selected TV signals in the unit of packets and outputs the restored digital data to the demultiplexer 104. The demultiplexer 104 separately extracts audio data, video data, and additional information data from the restored digital data and outputs the extracted audio, video, and additional information data in separate bit streams.

The audio data is decoded and converted into analog audio signals via the audio data processor 105 and is ultimately output through the speaker 107. Particularly, the audio data processor 105 processes the analog audio signals in a format of an audio equalizer, mono, stereo, surround, echo, etc. in accordance with audio control information determined by the controller 109.

Further, the video data is converted into red (R), green (G), and blue (B) color video signals via the video data processor 106 and are ultimately output through the display device 108. Particularly, the video data processor 106 processes the color video signals in accordance with video control information determined by the controller 109 to vary the resolution, brightness, contrast, etc.

The memory 110 includes a control mode table preliminarily designed to store information on various TV viewing conditions in corresponding areas in accordance with the type of TV program.

In designing the control mode table of the memory 110, program modes are categorized by, for example (but not by way of limitation), standard, sports, concert, movie, news, and user selection modes. Information on TV viewing conditions is subdivided into, for example (but not by way of limitation), video control, audio control, and additional function control information.

Here, the user selection mode is a mode for viewing any type of TV program under conditions selected by a user, and the standard mode is a mode for viewing any type of TV program in standard conditions, regardless of the type of TV program. The user selection mode and the standard mode can be selectively enabled using the key input device 111.

The video control information includes (but is not limited to) for example, information on resolution, color, brightness, and contrast tuning points. The audio control information includes (but is not limited to) for example, information on whether mono, stereo, surround, echo, Dolby, or other signal processing is applied along with information on audio equalizer tuning points. Further, the additional function control information includes, for example, information on additional functions such as language selection for bi-lingual programs.

The control mode table of the memory 110 and the information on the TV viewing conditions are designed to optimize video, audio, and other viewing conditions in accordance with the type of program.

For example, in a case of the video control information for a sports program, the resolution tuning point is adjusted to considerably increase the resolution, and the brightness and the contrast tuning points are adjusted to be at slightly higher points. As for the audio control information in the case of the sports program, a surround sound mode is enabled to provide an active atmosphere, and frequency characteristics of the audio equalizer are determined as standard frequency characteristics.

Meanwhile, in a case of the video control information for a movie program, the resolution tuning point is lowered to enable the viewing of smooth images, and the brightness and the contrast tuning points are slightly lowered to provide a theater atmosphere. As for the audio control information in the case of a movie program, a stereo sound mode is enabled, and frequency characteristics of the audio equalizer are determined to make low-pitched tones more distinctive than high-pitched tones.

As described above, the video control, audio control, and additional function control information is determined to provide optimum TV viewing conditions in accordance with the type of program such as concert, movie, news, etc.

The additional information data extracted through the demultiplexer 104 is processed through the controller 109 as follows.

When the additional information data is received, the controller 109 detects information on the type of TV program from the additional information data. If the detected information is different from the information currently stored, then the information on the type of program is updated with the detected information, and information on the TV viewing conditions corresponding to the detected information on the type of program is read from the control mode table of the memory 110. Among the information on the TV viewing condition, which is read from the control mode table of the memory 110, video control information is output to the video data processor 106, and audio control information is output to the audio data processor 105 so the previously fixed tuning points related to video and audio signal processing can be adjusted.

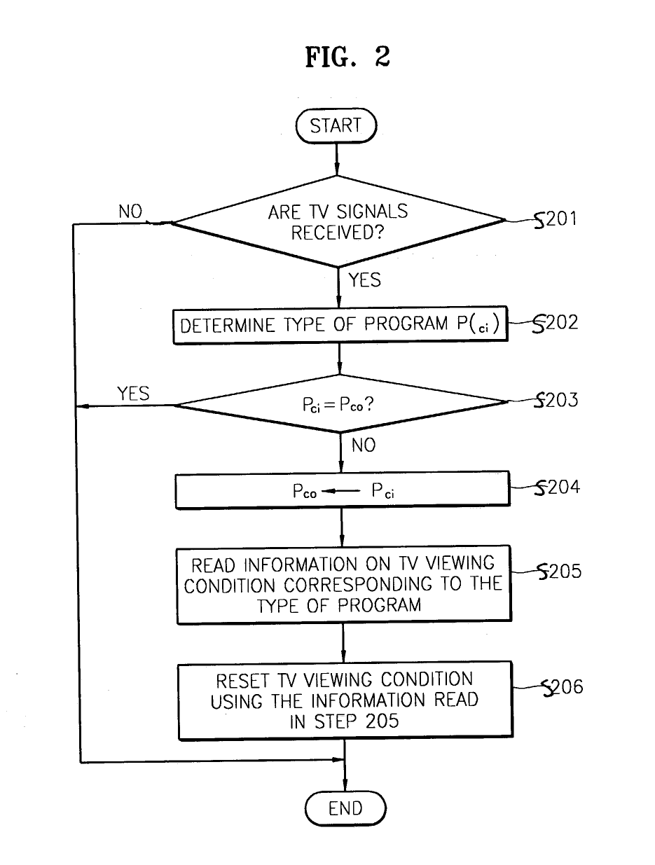

Now, an automatic control method of adaptively optimizing TV viewing conditions according to an exemplary, non-limiting embodiment of the present invention (i.e., operations of the controller 109) will be described with reference to FIG. 2.

First, it is determined whether TV signals for a selected channel, which include information on the type of the program, have been received (STEP S201). If it is determined in STEP S201 that the TV signals for the selected channel, which include information on the type of the program, have been received, then the type of the program is selected, and the selected type of the program (Pci) is determined (STEP S202).

The type of the program (Pci) determined in STEP S202 is compared with the type of program (Pco) temporarily stored at present. If both types are identical, the control process comes to an end, since already fixed TV viewing conditions are adequate for the currently received program (STEP S203).

However, if the type of program (Pci) determined in STEP S202 is different from the type of program (Pco) temporarily stored at present, the type of program (Pco) temporarily stored at present is replaced with the type of program (Pci) as was determined in STEP S202 (STEP S204).

Thereafter, information on the TV viewing conditions corresponding to the type of program (Pci) determined in STEP 202 is read from the control mode table of the memory 110 (STEP S205). Here, the information on the TV viewing conditions is information on predetermined control modes of a TV having variable control mode, and includes at least video control information and audio control information.

Then, previously fixed tuning points for processing audio and video signals and additive functions are updated in accordance with the information on the TV viewing conditions read from the control mode table of the memory 110 (STEP S206).

As described above, according to the present invention, TV viewing conditions can be automatically and optimally controlled in accordance with the type of program. Since there is no need to manually control the TV viewing conditions when the program is changed, users can always conveniently and automatically enjoy TV programs in optimum viewing conditions in accordance with the type of program.

The present invention can be implemented on a recording medium with a code that is readable by a computer. The recording medium that can be read by a computer may include any type of recording devices in which data that is readable by the computer is stored. Examples of the recording medium include electronic circuits, semiconductor devices, ROM, flash memory, E²PROM (electrically erasable programmable read-only memory), floppy discs, optical discs, hard discs, optical fibers, radio frequency (RF) network, and even carrier waves, for example, transmission over the Internet. Moreover, the recording medium may be distributed among computer systems that are interconnected through a network, and the present invention may be stored and implemented as a code in the distributed system.

While the present invention has been particularly shown and described with reference to preferred embodiments thereof, it will be understood by those of ordinary skill in the art that various changes in form and details may be made therein without departing from the spirit and scope of the present invention as defined by the appended claims.

What is claimed is:

1. An automatic control apparatus for adaptively optimizing television (TV) viewing conditions in a TV signal processing device, comprising:
a memory that stores information indicative of a viewing condition in a corresponding area of a control mode table, wherein said information is categorized according to at least program;
a signal receiving unit that receives a signal;
a demultiplexer that separates a video signal, an audio signal, and an additional information signal from the received signal;
a controller that determines a type of a current program, reads the information on the viewing condition, which corresponds to the type of the current program, from the memory, and sets up the viewing condition according to the information read from the memory; and
a signal processor that processes the video signal and the audio signal output from the demultiplexer in accordance with the viewing condition.

2. The apparatus of claim 1, wherein the program is categorized into at least one of sports, concert, movie, and news.

3. The apparatus of claim 1, wherein the information on the viewing condition is information on a predetermined control mode of a TV having a variable control mode.

4. The apparatus of claim 1, wherein the information on the viewing condition includes at least information on an image control mode and information on a sound control mode.

5. An automatic control method of adaptively optimizing television (TV) viewing conditions in a TV signal processing device, comprising the steps of:
(a) determining a type of a current program based on additional information included in a received signal;
(b) when the type of the current program determined in step (a) is different from a type of the previous program for which viewing conditions have been set, reading information from a memory on a viewing condition that corresponds to the type of the current program; and
(c) resetting the viewing conditions in accordance with the information read from the memory in step (b).

6. The method of claim 5, wherein the program is categorized into one of sports, concert, movie, and news.

7. The method of claim 5, wherein the information on the viewing condition is information on a predetermined control mode of a TV having a variable control mode.

8. The method of claim 5, wherein the information on the viewing condition includes at least information on an image control mode and information on a sound control mode.

9. The method of claim 5, further comprising determining whether a signal has been received prior to said step (a).

10. The apparatus of claim 1, said signal receiving unit comprising:
a tuner that receives said signal from a transmission capturing device; and
a channel decoder that decodes said received signal, and outputs said decoded signal to said demultiplexer.

11. The apparatus of claim 1, said processor comprising:
an audio data processor that receives an audio bit stream from said demultiplexer and generates an output to an audio output generation device; and
a video data processor that receives a video bit stream from said demultiplexer and generates an output to a display device.

12. A computer readable medium for storing a set of instructions for adaptively optimizing television (TV) viewing conditions in a TV signal processing device, said instructions comprising:
(a) determining a type of a current program based on additional information included in a received signal;
(b) when the type of the current program determined in instruction (a) is different from a type of the previous program for which a viewing condition has been set, reading information from a memory on a viewing condition that corresponds to the type of the current program; and
(c) resetting the viewing conditions in accordance with the information read from the memory in instruction (b).

13. The computer readable medium of claim 12, wherein the program is categorized into one of sports, concert, movie, and news.

14. The computer readable medium of claim 12, wherein the information on the viewing condition is information on a predetermined control mode of a having a variable control mode.

15. The computer readable medium of claim 12, wherein the information on the viewing condition includes at least information on an image control mode and information on a sound control mode.

16. The computer readable medium of claim 12, further comprising determining whether a signal has been received prior to said instruction (a).

17. The computer readable medium of claim 12, wherein said computer readable medium comprises one of an electronic circuit, a semiconductor device, a read-only memory, a flash memory, an electrically erasable programmable read-only memory, a floppy disk, an optical disk, a hard disc, an optical fiber, a radio frequency network, carrier waves, Internet transmission means.

18. The apparatus of claim 11, wherein said audio data processor processes an analog sound signal in a format of one of audio equalizer, mono, stereo, surround and echo.

19. The apparatus of claim 11, wherein said a video data processor receives video data that is converted into red, green and blue color video signals to vary at least one of resolution, brightness and contrast.
